(19) United States
(12) Patent Application Publication
(10) Pub. No.: US 2024/0100981 A1
(43) Pub. Date: Mar. 28, 2024

(54) TURBOCHARGED ELECTRIC GENERATOR

(71) Applicant: Nicholas Sarno, Waxhaw, NC (US)

(72) Inventor: Nicholas Sarno, Waxhaw, NC (US)

(21) Appl. No.: 18/241,367

(22) Filed: Sep. 1, 2023

Related U.S. Application Data
(60) Provisional application No. 63/410,440, filed on Sep. 27, 2022.

(51) Int. Cl. B60L 53/52

(52) U.S. Cl. CPC B60L 53/52; B60L 2220/50; B60L 2260/40

(57) ABSTRACT

A system for harnessing wind energy while an electric vehicle is in motion and converting the wind energy into electricity to charge a battery of the electric vehicle. The system includes a turbocharger for funneling air from the air intake of the electric vehicle to power a turbine that is housed within the turbocharger. The turbine is configured to rotate a drive shaft that drives the electric generator of the invention. The electric generator is then used to deliver a voltage to an external circuit of the system.

### CROSS REFERENCES TO RELATED APPLICATIONS

This application is related to one or more prior filed applications. This application claims priority to and the benefit of U.S. Provisional Application No. 63/410,440, filed Sep. 27, 2022, which is hereby incorporated by reference in its entirety.

### BACKGROUND OF THE INVENTION

### 1. Field of the Invention

The present invention relates to electric generators, and more specifically to the use of turbochargers and turbines to charge the battery of an electric vehicle.

### 2. Description of the Prior Art

It is generally known in the prior art to provide an electric turbocharged generator that uses exhausted air from the cylinders of an internal combustion engine to power a turbine.

Prior art patent documents include the following:

U.S. Pat. No. 8,653,677 for Electromagnetic, continuously variable transmission power split turbo compound and engine and vehicle comprising such a turbo compound by inventor West, filed Jan. 12, 2010 and issued Feb. 18, 2014, is directed to an electromagnetic, continuously variable transmission power split turbo compound including a turbo compound turbine driven by exhaust gases from an internal combustion engine, and a power split device comprising a magnetic gear arrangement. The magnetic gear arrangement includes a high speed rotor comprising a first quantity of permanent magnets, a low speed rotor comprising a second quantity of permanent magnets, and a plural pole rotor between the high speed rotor and the low speed rotor. A first rotor of the high speed rotor, the low speed rotor, and the plural pole rotor includes a mechanical input drive adapted to be driven by the turbine. A second rotor of the high speed rotor, the low speed rotor, and the plural pole rotor includes a mechanical output drive. A third rotor of the high speed rotor, the low speed rotor, and the plural pole rotor is unconnected to a mechanical drive and includes a controlling rotor for controlling a ratio of input drive angular velocity to output drive angular velocity.

U.S. Pat. No. 7,383,684 for Hybrid engine by inventor Vuk, filed Apr. 10, 2006 and issued Jun. 10, 2008, is directed to an internal combustion engine including an exhaust manifold; an intake manifold; and a turbocharger including a turbine in communication with the exhaust manifold, and a compressor in communication with the intake manifold. An electrical generator is coupled with the turbine. A motor receives electrical input power from the generator and provides mechanical output power. A combustor selectively provides additional input power to the motor.

U.S. Pat. No. 7,076,954 for Turbocharger system by inventors Sopko, et al., filed Mar. 31, 2005 and issued Jul. 18, 2006, is directed to a system for controlling intake pressure of a combustion engine operably coupled to a power generation system including a sensor configured to output a signal indicative of a pressure in an intake system of the combustion engine and a sensor configured to output a signal indicative of a load on the power generation system. The system further includes a turbocharger operably coupled to the intake system. The system also includes an electric machine operably coupled to the turbocharger. The electric machine is configured to supply torque to the turbocharger. The system further includes a turbocharger controller operably coupled to the electric machine. The turbocharger controller is configured to control operation of the electric machine such that the turbocharger supplies a desired intake pressure to the combustion engine based at least partially on the signal indicative of a pressure in the intake system and the signal indicative of a load on the power generation system.

U.S. Pat. No. 11,105,259 for Turbo-electric turbo-compounding method by inventors Williams, et al., filed Sep. 28, 2018 and issued Aug. 31, 2021, is directed to exhaust gases from an engine, input to turbo-compounder, drive a bladed turbine rotor therein, which drives a multi-phase AC generator, the output of which is used to electrically drive a multi-phase induction motor, the rotor of which is mechanically coupled to the engine, so as to provide for recovering power to the engine. The multi-phase AC generator may be coupled to the engine either by closure of a contactor, engagement of an electrically-controlled clutch, or by control of either a solid-state switching or control system or an AC excitation signal, when the frequency (fGENERATOR) of the multi-phase AC generator meets or exceeds that (fMOTOR) of the multi-phase induction motor.

U.S. Pat. No. 10,844,779 for Cooling system for e-charger assembly by inventors Hehn, et al., filed Sep. 11, 2018 and issued Nov. 24, 2020, is directed to an e-charger including an outer housing and a rotor supported for rotation within the outer housing. A motor assembly is housed within the outer housing and includes an electric motor and a motor case. The electric motor is encased within the motor case. The electric motor is configured to drivingly rotate the rotor within the outer housing. Furthermore, the e-charger includes a cooling system configured to receive a coolant. The cooling system includes a manifold passage defined in the outer housing. The cooling system includes a first motor cooling circuit and a second motor cooling circuit that are cooperatively defined by the outer housing and the motor case. The first motor cooling circuit and the second motor cooling circuit are fluidly connected to the manifold passage. The manifold passage is configured to distribute a flow of the coolant between the first motor cooling circuit and the second motor cooling circuit.

U.S. Pat. No. 10,677,253 for Turbocharger assembly by inventors Merritt, et al., filed Dec. 12, 2016 and issued Jun. 9, 2020, is directed to a turbocharger assembly including a shaft sleeve that includes a bore that extends between a first end and a second end; a shaft received by the bore of the shaft sleeve where the shaft includes a compressor end and a turbine wheel that defines a turbine end; and a balance collar disposed on the shaft and seated axially between the end of the shaft sleeve and the turbine wheel wherein the balance collar includes a stem portion and a flared portion that includes a sacrificial portion.

U.S. Pat. No. 10,612,459 for Methods and system for operating an electric turbocharger by inventors Matthews, et al., filed Jan. 18, 2018 and issued Apr. 7, 2020, is directed to systems and methods for operating an internal combustion engine that include an electric turbocharger. The systems and methods may operate the electric turbocharger in a motor mode or a generator mode. The electric turbocharger may be operated in a generator mode to reduce an amount of time to activate electric turbocharger in a motor mode.

U.S. Pat. No. 10,364,786 for Controller and internal combustion engine system by inventors Ueno, et al., filed Dec. 6, 2016 and issued Jul. 30, 2019, is directed to a controller for an internal combustion engine including a regenerative device and at least one of ignition timing circuitry and opening degree circuitry. The ignition timing circuitry is configured to retard an ignition timing so as to decrease a torque generated by the internal combustion engine in a shift-up operation of a multi-stage automatic transmission during a supercharging operation by a supercharger. The opening degree circuitry is configured to reduce an opening degree of a throttle valve so as to decrease a torque generated by the internal combustion engine in a shift-up operation of a multi-stage automatic transmission during a supercharging operation by a supercharger. The regenerative device is coupled to a compressor or a turbine of the supercharger to regenerate rotational energy in the compressor or the turbine so as to decrease the torque in the shift-up operation during the supercharging operation.

### SUMMARY OF THE INVENTION

The present invention relates to the use of a turbocharger for powering an electric generator in an electric vehicle.

It is an object of this invention to provide a system that generates electricity through the use of turbines that harness wind energy flowing through the air intake of an electric vehicle.

In one embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the drive shaft extends through the turbine and the generator, such that rotation of the turbine causes rotation of the generator; wherein the at least one lead wire functionally connects the generator to the battery of the EV; and wherein rotation of the generator is operable to produce a current through electromagnetic induction created by the copper coil and the plurality of stator magnets to charge the battery of the EV through the at least one lead wire.

In another embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the drive shaft extends through the turbine and the generator, such that rotation of the turbine causes rotation of the generator; wherein the at least one lead wire functionally connects the generator to the battery of the EV; wherein rotation of the generator is operable to produce a current through electromagnetic induction created by the copper coil and the plurality of stator magnets to charge the battery of the EV through the at least one lead wire; and wherein the generator further includes at least one slip ring and at least one brush operable to facilitate a transfer of the current from the generator to the at least one wire.

In yet another embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the air inlet includes an air flow controller operable to control the airflow entering the turbocharged electric generator; wherein the air inlet includes a flowmeter operable to measure the airflow entering the air inlet; wherein the air inlet is connected to an air intake of the EV and positioned adjacent to a front headlight of the EV; wherein the drive shaft extends through the turbine and the generator, such that rotation of the turbine causes rotation of the generator; wherein the at least one lead wire functionally connects the generator to the battery of the EV; and wherein rotation of the generator is operable to produce a current through electromagnetic induction created by the copper coil and the plurality of stator magnets to charge the battery of the EV through the at least one lead wire.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates an orthogonal side sectional view of a turbocharged electric generator according to one embodiment of the present invention.

FIG. 2 illustrates an orthogonal side view of a turbocharged electric generator according to one embodiment of the present invention.

FIG. 3A illustrates an orthogonal side view of a turbine and drive shaft according to one embodiment of the invention.

FIG. 3B illustrates an orthogonal side view of a turbine and drive shaft according to another embodiment of the invention.

FIG. 4 illustrates a perspective view of an electric generator according to one embodiment of the invention.

FIG. 5 illustrates an orthogonal side view of a turbocharged electric generator according to one embodiment of the invention.

FIG. 6 is a schematic diagram of a system of the present invention.

### DETAILED DESCRIPTION

The present invention is generally directed to turbine generators and more specifically to the use of a turbocharger to power an electric generator.

In one embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the drive shaft extends through the turbine and the generator, such that rotation of the turbine causes rotation of the generator; wherein the at least one lead wire functionally connects the generator to the battery of the EV; and wherein rotation of the generator is operable to produce a current through electromagnetic induction created by the copper coil and the plurality of stator magnets to charge the battery of the EV through the at least one lead wire.

In another embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the drive shaft extends through the turbine and the generator, such that rotation of the turbine causes rotation of the generator; wherein the at least one lead wire functionally connects the generator to the battery of the EV; wherein rotation of the generator is operable to produce a current through electromagnetic induction created by the copper coil and the plurality of stator magnets to charge the battery of the EV through the at least one lead wire; and wherein the generator further includes at least one slip ring and at least one brush operable to facilitate a transfer of the current from the generator to the at least one wire.

In yet another embodiment, the present invention is directed to a system for charging a battery of an Electric Vehicle (EV) including a turbocharged electric generator including a turbine, a drive shaft, a generator, and an air inlet; wherein the generator includes a plurality of stator magnets, a copper coil, and at least one lead wire; wherein the air inlet is operable to direct airflow produced by movement of the EV to rotate the turbine; wherein the air inlet includes an air flow controller operable to control the airflow entering the turbocharged electric generator; wherein the air inlet includes a flowmeter operable to measure the airflow entering the air inlet; wherein the air inlet is connected to an air intake of the EV and positioned adjacent to a front headlight of the EV; wherein the drive shaft extends through the turbine and the generator, such that rotation of the turbine causes rotation of the generator; wherein the at least one lead wire functionally connects the generator to the battery of the EV; and wherein rotation of the generator is operable to produce a current through electromagnetic induction created by the copper coil and the plurality of stator magnets to charge the battery of the EV through the at least one lead wire.

None of the prior art discloses the use of a turbocharger in an electric vehicle to harness wind energy and power an electric generator to charge the battery of an electric vehicle.

The prior art discloses the use of a traditional turbocharger in an internal combustion engine to harness energy from exhaust gases to power an electric generator. Prior art documents such as U.S. Pat. No. 10,612,459 and U.S. Pat. No. 11,105,259 disclose systems that harness exhausted gasses from the exhaust stroke of an internal combustion engine to power a generator to produce electricity and charge capacitors. The present invention is designed for electric vehicles and uses a modified turbocharger to harness energy from the air intake, rather than the exhaust stroke, to power an electric generator.

Traditional internal combustion automobiles have air intakes in the front of the automobile to harness air for the internal combustion engine. In a naturally aspirated internal combustion engine automobile, the harnessed air passes through an air filter before entering the intake manifold where the air is distributed into each cylinder of the engine. In a turbocharged internal combustion engine, harnessed air passes through an air filter before being compressed by the turbocharger and subsequently distributed into each cylinder of the internal combustion engine. Electric vehicles (EVs), by contrast, do not have an internal combustion engine and typically are designed with a minimal drag coefficient to increase efficiency. Because EVs are designed with a minimal drag coefficient, EVs intentionally harness little to no air when in use. The system of the present invention is intended to be fitted in an EV that is designed to harness external air flow such that the harnessed air powers a turbocharged electric generator.

When any automobile, including an EV, is moving it experiences air resistance. Automobiles with an internal combustion engine harness this air and mix it with fuel to power the internal combustion engine. EVs, on the other hand, are designed to reduce air resistance as much as possible because traditional EVs do not require any air to power the motors. However, it is impossible for EVs to eliminate air resistance completely, and this air resistance ultimately reduces the battery range of the EV. It is a purpose of the present invention to convert the energy from unavoidable air resistance present when an automobile is in motion into electricity used to charge the battery of the EV.

Some automobiles with an internal combustion engine use a device called a turbocharger to create forced induction. Forced induction is when the air that enters the intake of the automobile is compressed into a denser gas before entering the cylinder of the internal combustion engine. The compression of air before entering the cylinder of an internal combustion engine allows for more fuel to enter the cylinder enabling the combustion within the cylinder to produce more power. The turbocharger of an internal combustion engine is driven by exhausted gasses from the cylinder of an internal combustion engine. The turbocharger allows for energy from the exhausted gasses, that would have otherwise been wasted, to be recycled and converted into mechanical energy.

EVs do not use an internal combustion engine, and for this reason a traditional turbocharger that is powered by exhausted gasses is not applicable for EVs. The present invention uses a modified turbocharger to generate electricity. The modified turbocharger is powered by air that is harnessed by an EV experiencing air resistance as it is in motion. This is advantageous because the system is converting energy that would have otherwise reduced the efficiency of the EV to charge the battery and increase the range of the EV.

In one embodiment, the system has two operating modes, economy mode and performance mode. In economy mode, continual airflow is channeled through the system and travels through a series of ducts to force air out of the rear of a vehicle. Economy mode is optimal for increasing range efficiency because directly behind the rear bumper of a vehicle is where there is the least air resistance. In performance mode, the system channels continuous airflow through a series of ducts and directs the outflowing air to the top rear of a vehicle to create downforce. In performance mode, the downforce caused by the outflowing air reduces range efficiency but increases the vehicle's grip to the road, enabling better handling and acceleration.

Referring now to the drawings in general, the illustrations are for the purpose of describing one or more preferred embodiments of the invention and are not intended to limit the invention thereto.

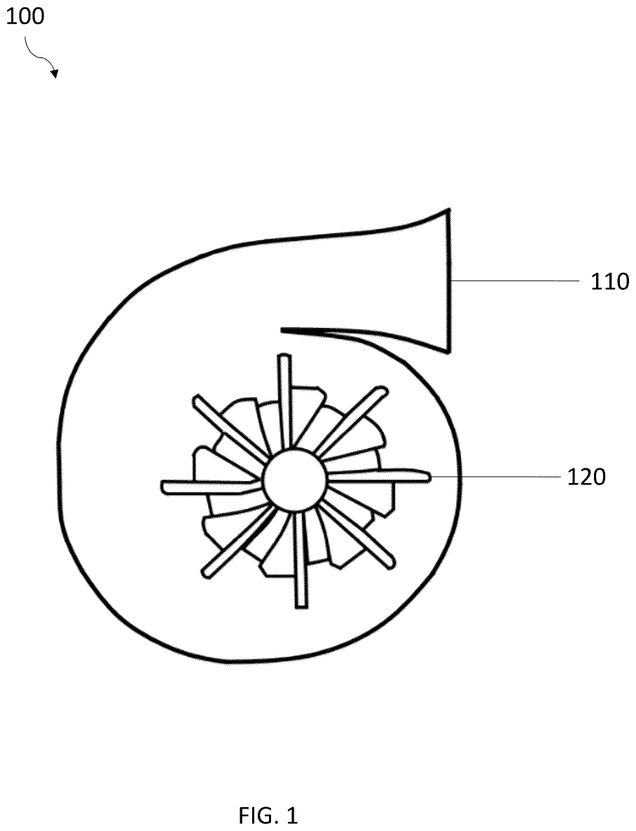

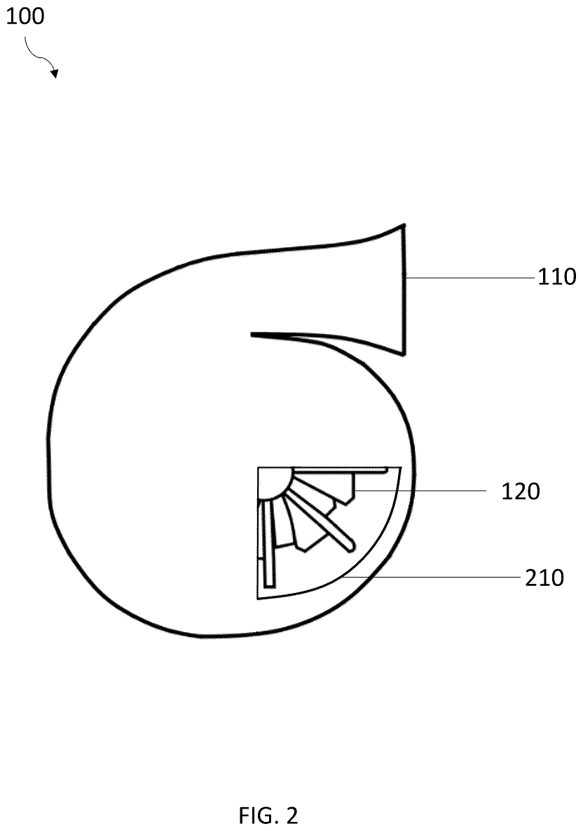

FIGS. 1-3B illustrate different components of a turbocharged electric generator 100. A turbocharger of the system includes a turbine 120 and an air inlet 110. The air inlet is located at the top of the turbocharge and is designed to funnel air flow into the turbocharger. The air inlet 110 is positioned and directed towards the front of the EV to optimize air flow into the turbocharger. In one embodiment, the air inlet 110 is connected to an air intake of an EV that is positioned adjacent to a front headlight of the EV. In another embodiment, the air inlet 110 is connected to an air intake of an EV that is positioned in the front hood of an EV. In yet another embodiment, the air inlet 110 is connected to an air intake of an EV that is positioned in the front driver side or passenger side wheel well of an EV. In a preferred embodiment, a turbocharged electric generator of the system is located in front of the front firewall of the vehicle. Advantageously, this positioning of the turbocharged electric generator allows for adequate space to install the ductwork necessary to control the flow of incoming and outgoing air.

In one embodiment, the system includes an air intake, ducting, and a vent. The air intake is operable to allow air into the system, the vent is operable to funnel air out of the system, the ducting connects the air intake to the air inlet of the turbocharger and the ducting connects the air outlet of the turbocharger to the vent. As the EV moves, air is pulled into the air intake and flows into the turbine; air exiting the turbine is funneled from the turbine to the vent and released. In one embodiment, the vent is positioned substantially toward the rear of the EV. In one embodiment, the vent is positioned on the underside of the EV. In one embodiment, the ducting includes, but is not limited to, polyvinyl chloride (PVC), thermoplastic rubber, silicone, aluminum, stainless steel, fiberboard, and/or fiberglass.

In another embodiment, a turbocharged electric generator of the system is located in the bottom rear of the vehicle and uses air pickup intakes to harness air. In one embodiment, the air inlet 110 funnels filtered air into the turbocharged electric generator 100. In another embodiment, the air inlet 110 includes at least one air filter built into to it to filter the air from the air intake of an EV. Once the air enters the air inlet 110 of the turbocharged electric generator 100, the air flows through the turbocharger and rotates the turbine 120. The blades of the turbine 120 are contoured to increase air pressure on the turbine and to increase the rotational speed of the turbine 120. Because air flows from high pressure to low pressure, the air enters the air inlet 110 with a high velocity and moves towards the low pressure air outlet 210. The air outlet 210 is located 180 degrees from the air inlet 110. This means that after the air enters the air inlet 110 it travels 180 degrees around the turbocharger and/or the turbine before exiting through the air outlet 210. In one embodiment, the air inlet includes at least one flow controller operable to control the amount of air entering the turbocharger. In one embodiment the flow controller is an air flow controller. In one embodiment, the at least one flow controller is operable to decrease the amount of air entering the turbocharger. In one embodiment, the at least one flow controller is operable to allow air to enter the turbocharger unrestricted. The flow controller is operable to force air across the turbine blades when the vehicle is moving at lower speeds to compensate for the decrease in air flow from the EV air intake. In one embodiment, the at least one flow controller includes, but is not limited to, a globe valve, a check valve, a needle valve, and/or a ball valve. In one embodiment, the at least one flow controller includes at least one flowmeter, operable to measure the amount of air flow. In one embodiment, the at least one flowmeter includes, but is not limited to, a piston flow meter, a gear flow meter, and/or a helical flow meter. In one embodiment, the flowmeter is operable to functionally communicate with an internal computer of the EV, such that the airflow is displayed, in real time, to the driver of the EV (through a display of the EV).

The turbocharger is designed such that harnessed air flow is pressurized as it travels through the turbine. As air is harnessed by the turbocharger, it begins at the air inlet 110 and then travels through the turbocharger towards the turbine 120. The cross sectional area of the air inlet 110 is larger in comparison to that of the housing of turbocharger. This causes the harnessed air flow to become pressurized and increase in flow rate as it travels through the turbocharger. Advantageously, the pressurized air is operable to rotate the turbine 120 at high velocities to produce enough energy to charge the batteries of an electric vehicle.

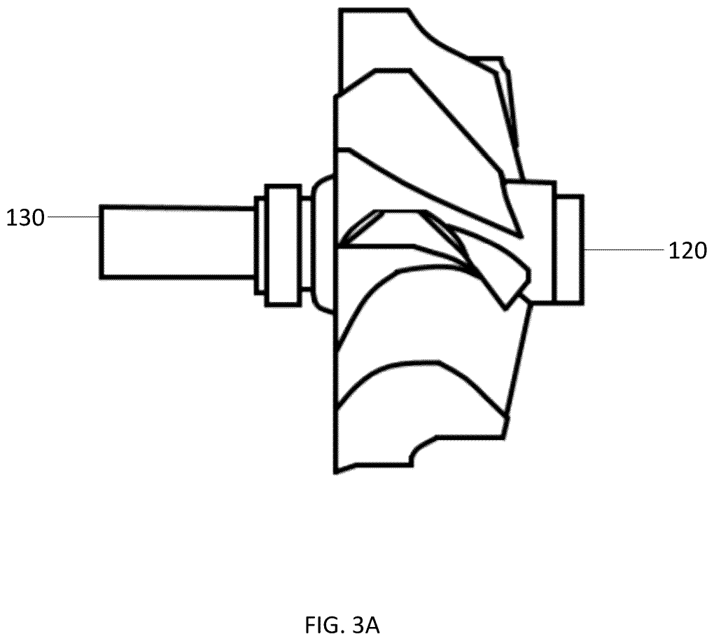

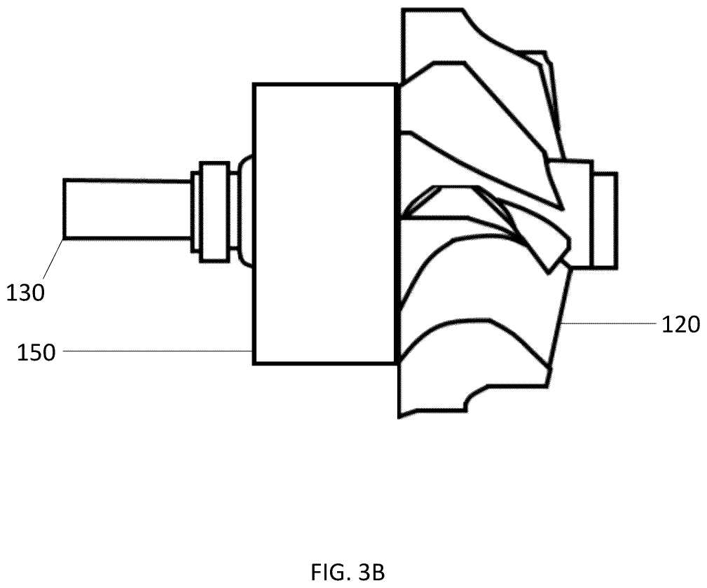

In one embodiment, a drive shaft 130 is coaxially connected to the center of the turbine 120, such that as the turbine 120 is rotating so does the drive shaft 130 (as illustrated in FIG. 3A). In this embodiment, the turbine 120 and drive shaft 130 are rotating at the same speed. In another embodiment, the drive shaft 130 is connected to a gear box 150 that is connected to the turbine 120 (as illustrated in FIG. 3B). The gear box 150 is operable to change the gear ratios between the turbine 120 and the drive shaft 130 such that the turbine 120 and the drive shaft 130 are rotating at different speeds. Using a higher gear ratio in the gear box 150 is advantageous in scenarios where the automobile is moving at lower speeds and the turbine 120 is not rotating at a high speed. If there is a higher gear ratio between the turbine 120 and the drive shaft 130, then the turbine 120 will rotate at a lower speed than the drive shaft 130. To manage heat created due to friction of the mechanical parts, the system distributes a lubricant throughout the drive shaft 130 and gear box 150 to reduce friction and ultimately prevent the system from overheating.

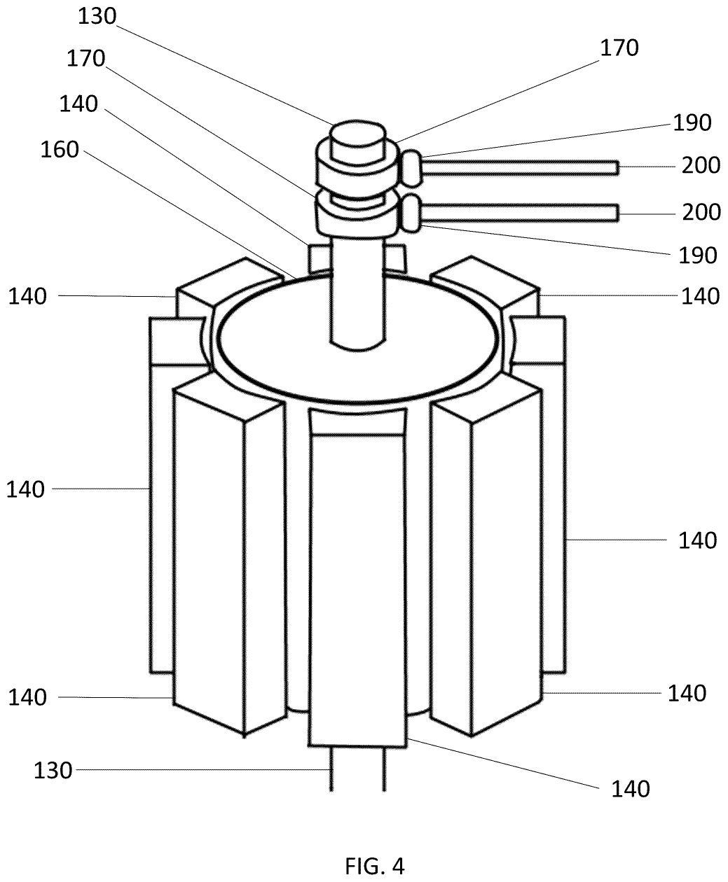

FIG. 4 illustrates the electric generator component of the turbocharged electric generator 100. The drive shaft 130 extends coaxially through the center of a rotor 160 and frictionally engages an inner side wall of the rotor 160, such that the drive shaft 130 drives rotation of the rotor 160 and both the drive shaft 130 and the rotor 160 rotate at the same speed. The rotor 160 is wrapped with copper wire that is coiled around the rotor 160. Stator magnets 140 are connected to and extend outwardly from a side wall of the rotor 160. The stator magnets 140 are positioned to create a strong magnetic field around the rotor 160. At the top of the drive shaft 130 are two slip rings 170 that each coaxially surround a section of the drive shaft 130. Each of the two slip rings 170 is in electrical contact with a brush 190, each of which is also in electrical contact with at least one lead wire 200. The at least one lead wire 200 are operable to connect to an external circuit to provide power generated by the rotor 160. In one embodiment, the generator of the present invention is operable to output at least approximately 30 amps to an external circuit. In one embodiment, the electric generator component of the turbocharged electric generator 100 is operable to provide power to at least one internal battery of an EV.

When harnessed air flow rotates the turbine 120, the rotor 160 rotates as well because the turbine 120 and the rotor 160 are mechanically coupled via the drive shaft 130. As the rotor 160 is rotating, a current is induced in the copper wire that is coiled around the rotor 160 due to the magnetic field generated by the stator magnets 140. The induced current is then transferred from the copper wire to the two slip rings 170 via an electric terminal connection. As the rotor 160 is rotating so too are the two slip rings 170. While the two slip rings 170 rotate, each slip ring 170 makes electrical contact with the two brushes 190. The electrical contact between the two slip rings 170 and two brushes 190 transfers the induced current to the two brushes from which the current can be delivered to an external circuit by the at least one lead wire 200.

In an alternative embodiment, the drive shaft 130 rotates rotor magnets inside of a stator coil. As the rotor is rotating the magnets, an alternating current is induced in the copper wire that is coiled around a stator surrounding the rotor. The induced current in the stator wire is a result of the changing magnetic field generated by the rotor magnets. Once an alternating current is generated in the stator coil, the alternating current is then transferred to an external circuit via at least one lead wire.

In one embodiment, the external circuit connected to the at least one lead wire 200 is operable to charge a battery of an EV as it is driving. In another embodiment, the external circuit connected to the at least one lead wire 200 is operable to directly power an electric motor of an EV.

The system is designed to charge half the cells of a battery pack of an electric vehicle while the other half of the battery pack of the electric vehicle is used to discharge and power the electric motors of the electric vehicle. The system is operable to designate either half of a battery pack as the charging cells and the other half as the discharging cells depending on which half is more depleted. The more depleted half of the battery pack will receive charging from the turbocharged electric generator while the less depleted half will discharge and power the electric motors. A computer of the system, including a processor and a memory, is operable to switch between which half of the battery pack is the charging pack and which one is the discharging pack. Alternatively, the system is operable to discharge both halves of the battery pack to send power to the motors of an electric vehicle whenever it is required to do so. By way of example, and not limitation, if the electric vehicle is demanding higher than normal power from the electric motors during acceleration, then the system will discharge both halves of the battery pack to meet the demands of the electric motors.

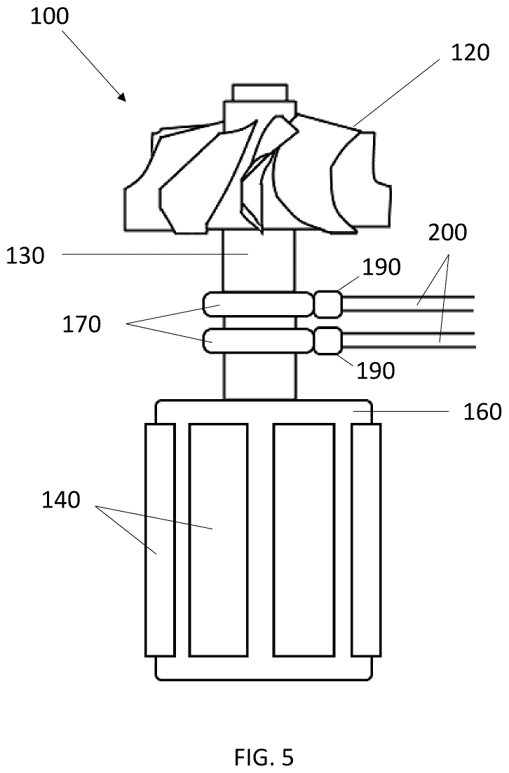

FIG. 5 is an orthogonal side view of a turbocharged electric generator 100 according to one embodiment of the present invention. In one embodiment, a turbine 120 is mechanically coupled to a drive shaft 130, wherein the drive shaft 130 is connected to an electric generator, wherein the electric generator includes a rotor 160, a plurality of stator magnets 140, at least one coil of copper wire, two slip rings 170, two brushes 190, and two lead wires 200, wherein the two lead wires 200 connect to an external circuit.

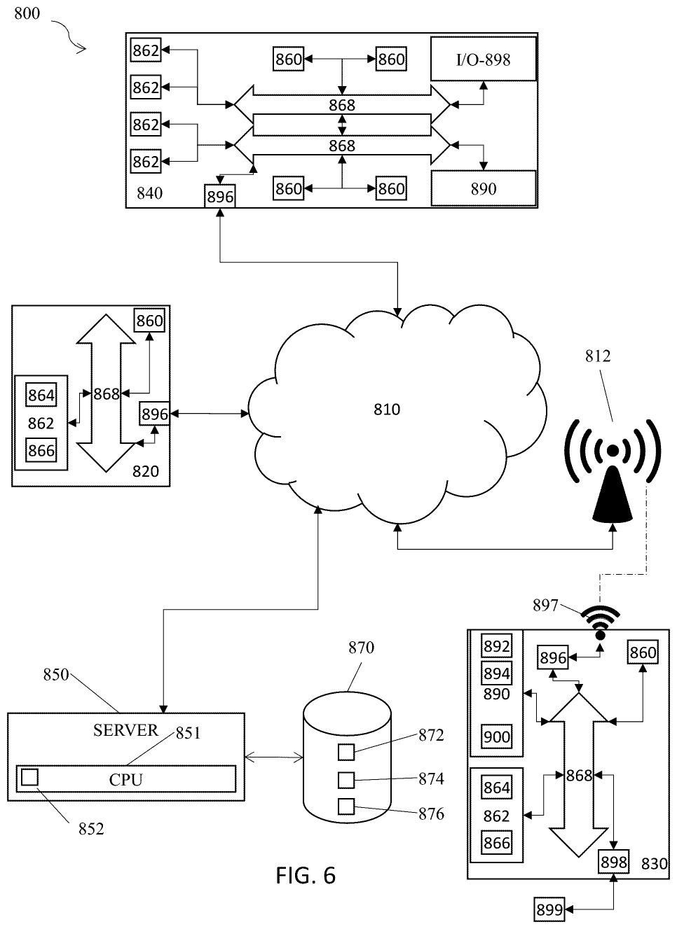

FIG. 6 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 6, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 6, is operable to include other components that are not explicitly shown in FIG. 6, or is operable to utilize an architecture completely different than that shown in FIG. 6. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for charging a battery of an electric vehicle (EV) comprising:
a turbocharged electric generator including a turbine, a drive shaft, a generator, and an air inlet;
wherein the generator includes a plurality of stator magnets, a copper coil, and at least one lead wire;
wherein the air inlet is operable to direct airflow produced by movement of the EV to rotate the turbine;
wherein the drive shaft extends through the turbine and the generator, such that rotation of the turbine causes rotation of the generator;
wherein the at least one lead wire functionally connects the generator to the battery of the EV; and
wherein rotation of the generator is operable to produce a current through electromagnetic induction created by the copper coil and the plurality of stator magnets to charge the battery of the EV through the at least one lead wire.

2. The system of claim 1, wherein the generator further includes a gear box operable to change the gear ratio between the turbine and the drive shaft.

3. The system of claim 1, wherein the air inlet includes an air flow controller operable to control the airflow entering the generator.

4. The system of claim 1, wherein the air inlet includes a flowmeter operable to measure the airflow entering the air inlet.

5. The system of claim 1, wherein the air inlet is connected to an air intake of the EV positioned adjacent to a front headlight of the EV.

6. The system of claim 1, wherein the air inlet is positioned in the front driver side and/or passenger side wheel well of the EV.

7. The system of claim 1, wherein the air inlet includes at least one air filter.

8. The system of claim 1, wherein the generator further includes an air outlet.

9. The system of claim 8, wherein the air inlet and the air outlet are positioned such that air entering the air inlet travels 180 degrees around the turbine prior to exiting the air outlet.

10. The system of claim 1, wherein upon a setting of an economy operating mode being selected, airflow is directed through a plurality of ducts out of a rear of the EV.

11. The system of claim 1, wherein upon a setting of a performance operating mode being selected, airflow is directed through a plurality of ducts out of a top side of the EV.

12. The system of claim 1, wherein the generator further includes at least one slip ring and at least one brush operable to facilitate a transfer of the current from the generator to the at least one lead wire.

13. The system of claim 1, wherein the plurality of stator magnets are connected to and extend outwardly from a side wall of a rotor of the generator.

14. A system for charging a battery of an electric vehicle (EV) comprising:
a turbocharged electric generator including a turbine, a drive shaft, a generator, and an air inlet;
wherein the generator includes a plurality of stator magnets, a copper coil, and at least one lead wire;
wherein the air inlet is operable to direct airflow produced by movement of the EV to rotate the turbine;
wherein the drive shaft extends through the turbine and the generator, such that rotation of the turbine causes rotation of the generator;
wherein the at least one lead wire functionally connects the generator to the battery of the EV;
wherein rotation of the generator is operable to produce a current through electromagnetic induction created by the copper coil and the plurality of stator magnets to charge the battery of the EV through the at least one lead wire; and
wherein the generator further includes at least one slip ring and at least one brush operable to facilitate a transfer of the current from the generator to the at least one wire.

15. The system of claim 14, wherein the turbocharged electric generator further includes a gear box operable to change the gear ratio between the turbine and the drive shaft.

16. The system of claim 14, wherein the air inlet is connected to an air intake of the EV positioned adjacent to a front headlight of the EV.

17. The system of claim 14, wherein the turbocharged electric generator further includes an air outlet, and wherein the air inlet and the air outlet are positioned such that air entering the air inlet travels 180 degrees around the turbine prior to exiting the air outlet.

18. A system for charging a battery of an electric vehicle (EV) comprising:
a turbocharged electric generator including a turbine, a drive shaft, a generator, and an air inlet;
wherein the generator includes a plurality of stator magnets, a copper coil, and at least one lead wire;
wherein the air inlet is operable to direct airflow produced by movement of the EV to rotate the turbine;
wherein the air inlet includes an air flow controller operable to control the airflow entering the turbocharged electric generator;
wherein the air inlet includes a flowmeter operable to measure the airflow entering the air inlet;
wherein the air inlet is connected to an air intake of the EV and positioned adjacent to a front headlight of the EV;
wherein the drive shaft extends through the turbine and the generator, such that rotation of the turbine causes rotation of the generator;
wherein the at least one lead wire functionally connects the generator to the battery of the EV; and
wherein rotation of the generator is operable to produce a current through electromagnetic induction created by the copper coil and the plurality of stator magnets to charge the battery of the EV through the at least one lead wire.

19. The system of claim 18, wherein the generator further includes at least one slip ring and at least one brush operable to facilitate a transfer of the current from the generator to the at least one lead wire.

20. The system of claim 18, wherein the plurality of stator magnets are connected to and extend outwardly from a side wall of a rotor of the generator.
